(19) United States
(12) Patent Application Publication
(10) Pub. No.: US 2025/0149630 A1
(43) Pub. Date: May 8, 2025

(54) UV-TRIGGERED COMPOSITE GEL MEMBRANE WITH HIGH SOLID-ELECTROLYTE CONCENTRATION

(71) Applicant: GM GLOBAL TECHNOLOGY OPERATIONS LLC, Detroit, MI (US)

(72) Inventors: Yong LU, Shanghai (CN); Zhe Li, Shanghai (CN); Qili Su, Shanghai (CN); Haijing Liu, Shanghai (CN)

(21) Appl. No.: 18/914,838

(22) Filed: Oct. 14, 2024

(30) Foreign Application Priority Data
Nov. 3, 2023 (CN) 2023114614506

(51) Int. Cl. H01M 10/0565; H01M 4/02; H01M 10/0567; H01M 10/0568; H01M 10/0569; H01M 50/411

(52) U.S. Cl. CPC H01M 10/0565; H01M 10/0567; H01M 10/0568; H01M 10/0569; H01M 50/411; H01M 2004/027; H01M 2004/028

(57) ABSTRACT

A battery cell includes A anode electrodes, C cathode electrodes, and S separators arranged between the A anode electrodes and the C cathode electrodes, where A, C, and S are integers greater than one. The S separators include a composite gel membrane that is cured in-situ using ultraviolet light and includes a polymer, a solid electrolyte comprising greater than 20 wt % of the composite gel membrane, an initiator, and a liquid electrolyte.

### CROSS-REFERENCE TO RELATED APPLICATIONS

This application claims the benefit of Chinese Patent Application No. 202311461450.6 filed on Nov. 3, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including composite gel membranes.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes A anode electrodes, C cathode electrodes, and S separators arranged between the A anode electrodes and the C cathode electrodes, where A, C, and S are integers greater than one. The S separators include a composite gel membrane that is cured in-situ using ultraviolet light and includes a polymer, a solid electrolyte comprising greater than 20 wt % of the composite gel membrane, an initiator, and a liquid electrolyte.

In other features, the polymer comprises 5 wt % to 30 wt % of the composite gel membrane, the solid electrolyte comprises 20 wt % to 90 wt % of the composite gel membrane, the initiator comprises 0.1 wt % to 0.25 wt % of the composite gel membrane, and the liquid electrolyte comprises 10 wt % to 80 wt % of the composite gel membrane. The polymer comprises 8 wt % to 15 wt % of the composite gel membrane, the solid electrolyte comprises 35 wt % to 60 wt % of the composite gel membrane, the liquid electrolyte comprises 10 wt % to 15 wt % of the composite gel membrane, and the initiator comprises 0.1 wt % to 0.25 wt % of the composite gel membrane.

In other features, the initiator is selected from a group consisting of Norish type 1 initiator and a Norish type 2 initiator. The liquid electrolyte includes one or more solvents and one or more lithium salts. The liquid electrolyte further includes a solid electrolyte interface additive selected from a group consisting of vinylene carbonate (VC), vinyl ethylene carbonate (VEC), butylene carbonate (BC), fluoroethylene carbonate (FEC), 1,3-propane sultone (PS), ethylene sulfite(ES), Ethylene sulfate (DTD), and combinations thereof.

In other features, the one or more lithium salts have a concentration greater than or equal to 0.8 M/L. The one or more solvents are selected from a group consisting of ethylene carbonate (EC), dimethyl carbonate (DMC), Gamma-butyrolactone (GBL), propylene carbonate (PC), ethyl methyl carbonate (EMC), diethyl carbonate (DEC), and combinations thereof. The polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), their corresponding oligomers and co-polymers, and combinations thereof.

In other features, the the solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, borate-based electrolytes, and combinations thereof.

A method for manufacturing a free-standing composite gel membrane for a battery cell, includes providing a polymer film; supplying a slurry for a composite gel membrane comprising a polymer, a solid electrolyte comprising greater than 20 wt % of the composite gel membrane, and an initiator onto the polymer film; compressing the slurry and the polymer film between first and second rollers; and exposing the slurry to ultraviolet (UV) light for a predetermined period at a predetermined wavelength to polymerize the polymer.

In other features, the at least one of the first and second rollers includes a radially outer surface comprising one of rubber and plastic. The predetermined period is in a range from 30 to 600 s. The predetermined wavelength is in a range from 10 to 400 nm. Energy of the UV light is in a range from 0.5 J/cm3 to 3 J/cm3. The polymer comprises 5 wt % to 30 wt % of the composite gel membrane, the solid electrolyte comprises 20 wt % to 90 wt % of the composite gel membrane, and the initiator comprises 0.1 wt % to 1.0 wt % of the composite gel membrane.

In other features, the polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), their corresponding oligomers and co-polymers, and combinations thereof. The solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, borate-based electrolytes, and combinations thereof.

A method for manufacturing a free-standing electrode and separator for a battery cell includes providing an electrode; supplying a slurry for a composite gel membrane comprising a polymer, a solid electrolyte comprising greater than 20 wt % of the composite gel membrane, and an initiator onto the electrode; compressing the slurry and the electrode between first and second rollers; and exposing the slurry to ultraviolet (UV) light for a predetermined period at a predetermined wavelength to polymerize the polymer.

In other features, at least one of the first and second rollers includes a radially outer surface comprising one of rubber and plastic. The predetermined period is in a range from 30 to 600 s. The predetermined wavelength is in a range from 10 to 400 nm. The energy of the UV light is in a range from 0.5 J/cm3 to 3 J/cm3.

In other features, the polymer comprises 5 wt % to 30 wt % of the composite gel membrane, the solid electrolyte comprises 20 wt % to 90 wt % of the composite gel membrane, and the initiator comprises 0.1 wt % to 1.0 wt % of the composite gel membrane. The polymer is selected from a group consisting of polyethylene oxide (PEO), polyvinylidene fluoride (PVDF), polyvinylidene fluoride-hexafluoropropylene (PVDF-HFP), polypropylene oxide (PAN), (PPO), polyacrylonitrile polymethacrylonitrile (PMAN), polymethyl methacrylate (PMMA), and their corresponding oligomers and co-polymers. The solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, and borate-based electrolytes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a monopolar battery cell including cathode electrodes, anode electrodes, and separators arranged in a battery cell enclosure according to the present disclosure;

FIG. 2 is a side cross sectional view of an example of a bipolar battery cell including cathode electrodes, anode electrodes, and separators arranged in a battery cell enclosure according to the present disclosure;

FIG. 3 is a more detailed side cross sectional view of an example of a monopolar battery cell including cathode electrodes, anode electrodes, and separators arranged in a battery cell enclosure according to the present disclosure;

FIG. 4 is a more detailed side cross sectional view of an example of a bipolar battery cell including cathode electrodes, anode electrodes, and separators arranged in a battery cell enclosure according to the present disclosure;

FIG. 5 illustrates an example of a method for manufacturing a free-standing composite gel membrane according to the present disclosure; and

FIG. 6 illustrates an example of a method for manufacturing a free-standing electrode with a composite gel membrane according to the present disclosure.

In the drawings, reference numbers may be reused to identify similar and/or identical elements.

### DETAILED DESCRIPTION

While battery cells with composite gel membranes (CGMs) according to the present disclosure are shown in the context of electric vehicles, the battery cells with CGMs can be used in stationary applications and/or other applications.

Free-standing gel membranes can be used as separating layers for solid-state batteries (SSBs). The gel membranes help to improve layer-to-layer interfacial contact. However, internal short circuits may occur due to random defects in the gel membrane, especially when decreasing the thickness of the gel membrane for the purpose of enhancing the energy density. Using separate layers including solid electrolyte and the gel membrane causes an increase in thickness and reduces power capability.

Incorporating solid electrolytes (SEs) into gel membranes enables optimized reliability. However, preparing composite gel membranes with high SE concentrations and low thicknesses is still problematic due to the high viscosity of precursor solutions. The viscosity of precursor solutions for coating of CGMs increases dramatically with increasing SE concentrations. The high viscosity of the precursor solutions makes it difficult to apply during film coating processes. For example, gel precursor with 15 wt % SE has a viscosity of 700 MPas, gel precursor with 27 wt % SE has a viscosity of 1200 MPas, and gel precursor with 41 wt % SE has a viscosity of 16,800 MPas.

In some examples, composite gel membranes (CGMs) according to the present disclosure include solid electrolyte (SE) having a concentration greater 40 wt %, a polymer, an initiator, and liquid electrolyte. The composite gel membrane is triggered using an ultraviolet light (UV)-induced process. Free-standing CGMs and/or free-standing electrodes incorporating the CGMs improves the power capability of solid-state battery cells. In addition, the likelihood of short circuits when using the CGMs according to the present disclosure is significantly reduced.

Polymers formed during the UV in-situ polymerization process act as both skeletons for the gel electrolytes and binding materials for CGMs. In some examples, no processing solvents (e.g., as N-methyl-2-pyrrolidone (NMP)) or heating chambers are required. As a result, the battery cells using the CGMs according to the present disclosure have lower manufacturing cost and higher efficiency as compared to other comparable battery cells.

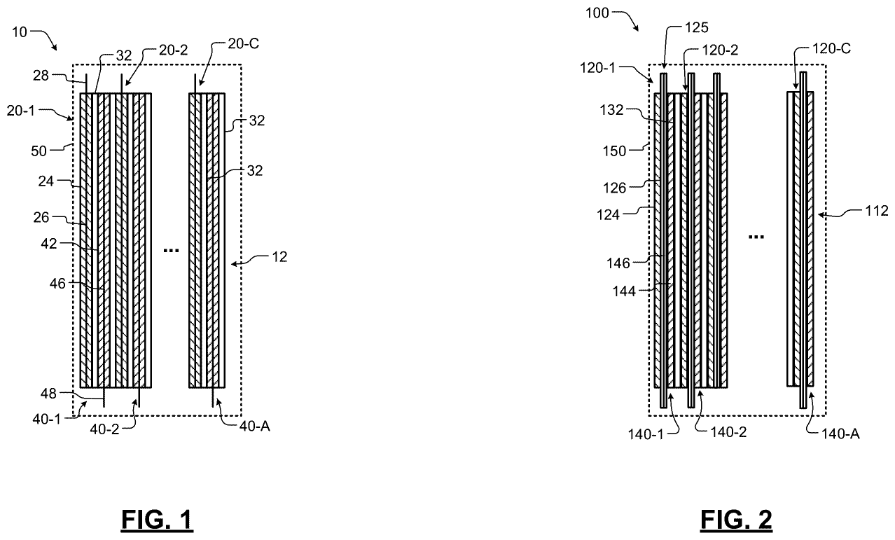

Referring now to FIG. 1, a monopolar battery cell 10 includes C cathode electrodes 20, A anode electrodes 40, and S separators 32 arranged in a predetermined sequence in a battery cell stack 12 located in an enclosure 50, where C, S and A are integers greater than zero. The S separators 32 include composite gel membranes as described herein.

The C cathode electrodes 20-1, 20-2, . . . , and 20-C include cathode active material layers 24 arranged on one or both sides of cathode current collectors 26. The A anode electrodes 40-1, 40-2, . . . , and 40-A include anode active material layers 42 arranged on one or both sides of the anode current collectors 46.

In some examples, the anode active material layers 42 and/or the cathode active material layers 24 are free-standing electrodes that are arranged adjacent to (or attached to) the cathode current collectors 26 and/or the anode current collectors 46, respectively. In some examples, the anode active material layers 42 and/or the cathode active material layers 24 comprise coatings including one or more active materials, one or more conductive fillers/additives, and/or one or more binder materials that are applied to the current collectors.

In some examples, the cathode current collectors 26 and/or the anode current collectors 46 comprise foil, mesh or expanded metal. In some examples, the cathode current collectors 26 and/or the anode current collectors 46 are made of one or more materials selected from a group consisting of copper, stainless steel, brass, bronze, zinc, aluminum, and/or alloys thereof. External tabs 28, 48 can be connected to the current collectors of the anode electrodes and cathode electrodes on the same or opposite sides of the battery stack. The external tabs 28, 48 are connected to terminals of the battery cells.

Referring now to FIG. 2, a bipolar battery cell 100 includes C cathode electrodes 120, A anode electrodes 140, and S separators 132 arranged in a predetermined sequence in a stack 112 located in an enclosure 150. The S separators 132 include composite gel membranes as described herein.

The C cathode electrodes 120-1, 120-2, . . . , and 120-C include cathode active material layers 124 arranged on a cathode current collector 126 of a bipolar current collector 125. The A anode electrodes 140-1, 140-2, . . . , and 140-A include anode active material layers 142 arranged on an anode current collector 146 of the bipolar current collector 125. In some examples, the cathode current collector 126 of the bipolar current collector 125 comprises aluminum foil and the anode current collector 146 of the bipolar current collector 125 comprises copper foil, although other materials can be used.

In some examples, the anode active material layers 142 and/or the cathode active material layers 124 are free-standing electrodes that are arranged adjacent to (or attached to) the bipolar current collectors 125. In some examples, the anode active material layers 142 and/or the cathode active material layers 124 comprise coatings including one or more active materials, one or more conductive fillers/additives, and/or one or more binder materials that are applied to the anode or cathode layers of the current collectors. In some examples, the battery cells and/or electrodes are manufactured by applying a slurry to coat the current collectors in a roll-to-roll manufacturing process.

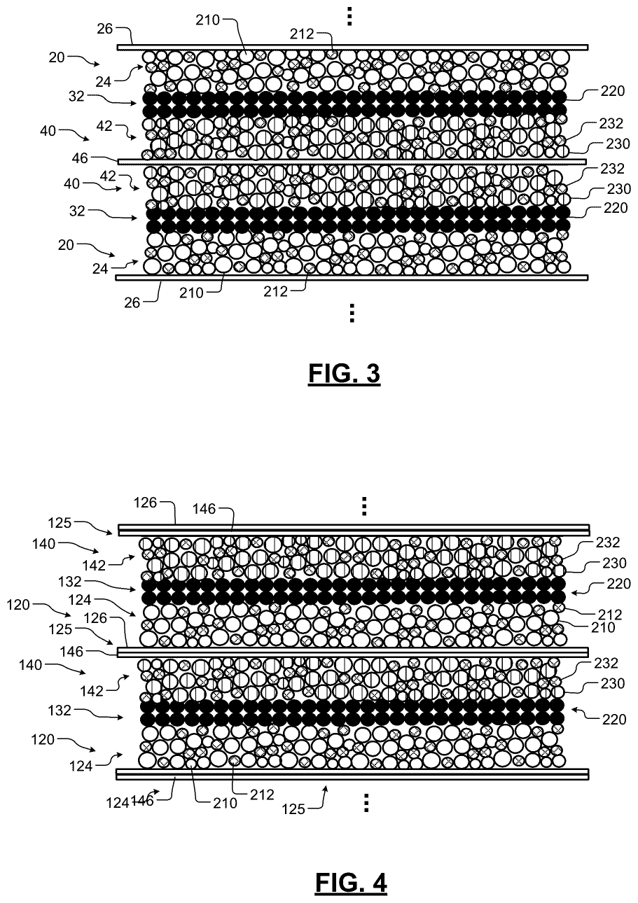

Referring now to FIG. 3, an example of the monopolar battery cell is shown. The cathode active material layer 24 comprises cathode active material 210 and solid electrolyte 212. The S separators 32 include a composite gel membrane 220. The anode active material layer 42 comprises anode active material 230 and solid electrolyte 232.

Referring now to FIG. 4, an example of the bipolar battery cell is shown. The cathode active material layer 124 comprises the cathode active material 210 and the solid electrolyte 212. The S separators 132 include the composite gel membrane 220. The anode active material layer 142 comprises the anode active material 230 and the solid electrolyte 232.

In some examples, the composite gel membrane 220 is a free-standing composite gel membrane including polymer, solid electrolyte, liquid electrolyte, and/or an initiator. In some examples, the polymer comprises 5 wt % to 30 wt % of the composite gel membrane, the solid electrolyte comprises 20 wt % to 90 wt % of the composite gel membrane, the liquid electrolyte comprises 10 wt % to 80 wt % of the composite gel membrane, and the initiator comprises 0.1 wt % to 1.0 wt % of the composite gel membrane.

In some examples, the polymer comprises 8 wt % to 15 wt % of the composite gel membrane, the solid electrolyte comprises 35 wt % to 60 wt % of the composite gel membrane, the liquid electrolyte comprises 10 wt % to 55 wt % of the composite gel membrane, and the initiator comprises 0.1 wt % to 0.25 wt % of the composite gel membrane.

In some examples, the polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), their corresponding oligomers and co-polymers, and combinations thereof.

In some examples, the solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, borate-based electrolytes, and combinations thereof.

Examples of oxide-based electrolytes include garnet type (e.g., Li₇La₃Zr₂O₁₂). Perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃), LISICON type (e.g., Li₂₊₂ₓZn₁₋ₓGeO₄), and combinations thereof.

In some examples, low cost electrolytes such as alumina Al₂O₃ or aluminum oxyhydroxide AlO(OH) are used.

Examples of metal-doped or aliovalent-substituted oxide-based electrolytes include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂, and combinations thereof.

Examples of sulfide-based electrolytes include Li₂S-P₂S₅ system, Li₂S-P₂S₅MOx system, Li₂S-P₂S₅-MSₓ sysytem, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}AS_{0.166}S₄, Lil-Li₄SnS₄, Li₄SnS₄, and combinations thereof.

Examples of nitride-based electrolytes include Li₃N, Li₇PN₄, and LiSi₂N₃. Examples of hydride-based electrolytes include LiBH₄, LiBH₄—LiX (X=chlorine (Cl), bromine (Br), or iodine (I)), LiNH₂, Li₂NH, LiBH₄—LiNH₂, and Li₃AlH₆. Examples of halide-based. e.g. Lil, Li₃InCl₆, Li₂CdCl₄, Li₂MgCl₄, Li₂Cdl₄, Li₂Znl₄, and Li₃OCl. Examples of borate-based electrolytes include Li₂B₄O₇, Li₂O—B₂O₃—P₂O₅, and combinations thereof.

In some examples, the liquid electrolyte includes one or more solvents and one or more lithium salts. In some examples, the lithium salts have a concentration greater than or equal to 0.8 M/L. In some examples, the solvents are selected from a group consisting of ethylene carbonate (EC), dimethyl carbonate (DMC), Gamma-butyrolactone (GBL), propylene carbonate (PC), ethylmethyl carbonate (EMC), diethyl carbonate (DEC), and combinations thereof.

In some examples, the lithium salts are selected from a group consisting of LiTFSI, LIFSI, LiBETl, LiPF₆, LiBOB, LIDFOB, LiBF₄, LiAsF₆, LiClO₄, LiTfO, and combinations thereof.

In some examples, the liquid electrolyte may further comprise one or more of solid electrolyte interface (SEI) additives. In some examples, the SEI additive is selected from a group consisting of vinylene carbonate (VC), vinyl ethylene carbonate (VEC), butylene carbonate (BC), fluoroethylene carbonate (FEC), 1,3-propane sultone (PS), ethylene sulfite(ES), ethylene sulfate (DTD), and combinations thereof.

In some examples, the initiator is selected from a group consisting of Norish type 1 initiator and a Norish type 2 initiator. In some examples, the Norish type 1 initiator is selected from a group consisting of 2,4,6-trimethylbenzoyldiphenyl phosphine oxide (TPO), hydroxyacetophenone (HAP), Irgacure 1173, Irgacure 184,Irgacure 369, Irgacure 651, and Irgacure 907. In some examples, the Norish type 2 initiator is selected from a group consisting of benzophenone, 2-isopropylthioxanthone, 4-methylbenzophenone, ethyl 4-dimethylaminobenzoate, 4-chlorobenzophenone, and combinations thereof.

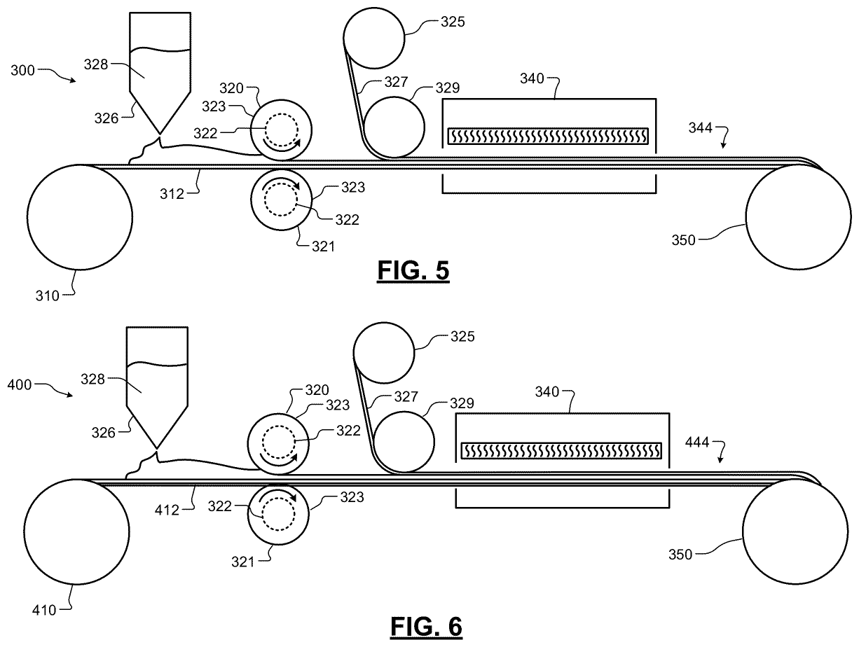

Referring now to FIG. 5, a method 300 for manufacturing a free-standing composite gel membrane is shown. A roll 310 of polymer film 312 is fed between a pair of rollers 320 and 321. A dispenser 326 supplies a slurry 328 for the composite gel membrane onto one surface of the polymer film 312. The rollers 320 and 321 compress the slurry. In some examples, a roll 327 supplies an additional polymer film 327 that is guided by a roller 327 onto an upper surface of the slurry. The additional polymer film prevents evaporation of liquid electrolyte. After passing through the rollers 320 and 321, the film and the slurry pass through a UV chamber 340 for UV curing. After curing and cooling, a free-standing composite gel membrane 344 is collected on a roll 350. In some examples, the polymer film 312 is removed prior to manufacturing of the battery cell including the composite gel membrane.

In some examples, one or both of the rollers 320 and 321 are different than metal-based rollers typically used in a roll-to-roll process. In some examples, one or both of the rollers 320 and 321 include soft materials such as rubber or plastic (e.g., PP, PTFE). In some examples, a radially outer surface of one of the rollers 320 and 321 has a metal surface.

In some examples, one or both of the rollers 320 and 321 have a core-shell structure. A core 322 is made of a rigid material such as metal (e.g., stainless steel) and a radially outer surface 323 of the core 322 includes a softer material than metal (e.g., rubber, plastic (e.g., PP, PTFE)). In some examples, the rollers 320 and 321 have a diameter in a range from 20 mm to 500 mm. In some examples, the rollers 320 and 321 have a diameter in a range from 50 mm to 200 mm. In some examples, the roller pressure is in a pressing pressure range from 0.01 T to 3.0 T. In some examples, the roller pressure is in a pressing pressure range from 0.05 T to 0.5 T.

Referring now to FIG. 6, a method 400 for manufacturing a free-standing electrode including a composite gel membrane is shown. A roll 410 including a free-standing electrode 412 (e.g., anode or cathode electrode) is fed between the pair of rollers 320 and 321. The dispenser 326 supplies the slurry 328 for the composite gel membrane onto one surface of the electrode 412. The rollers 320 and 321 compress the slurry 328 and the electrode 412. In some examples, the roll 327 supplies the additional polymer film 327 that is guided by the roller 327 onto an upper surface of the slurry. The additional polymer film prevents evaporation of liquid electrolyte. After passing through the rollers 320 and 321, the electrode 412 and the compressed slurry 328 pass through a UV chamber 340 for UV polymerization. After UV polymerization and cooling, a free-standing electrode 444 including a composite gel membrane is collected on the roll 350.

In some examples, UV curing is performed at a wavelength in a range from 100 to 400 nm. In some examples, UV curing is performed at a wavelength in a range from 340 to 380 nm (e.g., 365 nm). In some examples, the UV chamber supplies energy in a range from 0.25 J/cm² to 3 J/cm². In some examples, the UV chamber supplies energy in a range from 0.5 J/cm² to 1.5 J/cm². In some examples, the UV curing time is in a range from 30 s to 600 s. In some examples, the UV curing time is in a range from 50 s to 120 s.

In some examples, the polymer film comprises a non-adhesive plastic. In some examples, the non-adhesive plastic is selected from a group consisting of PET, PP, PMMA, PTFE etc.

In some examples, the electrodes have a width in a range from 50 mm to 500 mm. In some examples, the polymers in the CGMs include small molecules. For example, the polymers in the CGMs include monomers or oligomers (e.g., having a lower viscosity) that are dissolved in the CGM slurry and cross-linked during UV polymerization.

In some examples, the CGMs can be prepared as a free-standing separator (on a removeable film) or on free-standing electrodes (e.g., cathode and/or anode electrodes). No processing solvents and less electricity consumption are used due to the removal of heating and/or solvents recycling system. The process for forming the free-standing CGMs or free-standing electrodes with the CGMs is relatively fast (e.g., less than 10 min), which is enabled by UV polymerization.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
A anode electrodes;
C cathode electrodes; and
S separators arranged between the A anode electrodes and the C cathode electrodes, where A, C, and S are integers greater than one,
wherein the S separators comprise a composite gel membrane that is cured in-situ using ultraviolet light and includes a polymer, a solid electrolyte comprising greater than 20 wt % of the composite gel membrane, an initiator, and a liquid electrolyte.

2. The battery cell of claim 1, wherein the polymer comprises 5 wt % to 30 wt % of the composite gel membrane, the solid electrolyte comprises 20 wt % to 90 wt % of the composite gel membrane, the initiator comprises 0.1 wt % to 0.25 wt % of the composite gel membrane, and the liquid electrolyte comprises 10 wt % to 80 wt % of the composite gel membrane.

3. The battery cell of claim 1, wherein the polymer comprises 8 wt % to 15 wt % of the composite gel membrane, the solid electrolyte comprises 35 wt % to 60 wt % of the composite gel membrane, the liquid electrolyte comprises 10 wt % to 15 wt % of the composite gel membrane, and the initiator comprises 0.1 wt % to 0.25 wt % of the composite gel membrane.

4. The battery cell of claim 1, wherein the initiator is selected from a group consisting of Norish type 1 initiator and a Norish type 2 initiator.

5. The battery cell of claim 1, wherein the liquid electrolyte includes one or more solvents and one or more lithium salts.

6. The battery cell of claim 5, wherein the liquid electrolyte further includes a solid electrolyte interface additive selected from a group consisting of vinylene carbonate (VC), vinyl ethylene carbonate (VEC), butylene carbonate (BC), fluoroethylene carbonate (FEC), 1,3-propane sultone (PS), ethylene sulfite(ES), Ethylene sulfate (DTD), and combinations thereof.

7. The battery cell of claim 5, wherein the one or more lithium salts have a concentration greater than or equal to 0.8 M/L.

8. The battery cell of claim 5, wherein the one or more solvents are selected from a group consisting of ethylene carbonate (EC), dimethyl carbonate (DMC), Gamma-butyrolactone (GBL), propylene carbonate (PC), ethyl methyl carbonate (EMC), diethyl carbonate (DEC), and combinations thereof.

9. The battery cell of claim 1, wherein the polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), their corresponding oligomers and co-polymers, and combinations thereof.

10. The battery cell of claim 1, wherein the solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, borate-based electrolytes, and combinations thereof.

11. A method for manufacturing a free-standing composite gel membrane for a battery cell, comprising:
providing a polymer film;
supplying a slurry for a composite gel membrane comprising a polymer, a solid electrolyte comprising greater than 20 wt % of the composite gel membrane, and an initiator onto the polymer film;
compressing the slurry and the polymer film between first and second rollers; and
exposing the slurry to ultraviolet (UV) light for a predetermined period at a predetermined wavelength to polymerize the polymer.

12. The method of claim 11, wherein at least one of the first and second rollers includes a radially outer surface comprising one of rubber and plastic.

13. The method of claim 11, wherein:
the predetermined period is in a range from 30 to 600 s,
the predetermined wavelength is in a range from 10 to 400 nm, and
energy of the UV light is in a range from 0.5 J/cm³ to 3 J/cm³.

14. The method of claim 11, wherein the polymer comprises 5 wt % to 30 wt % of the composite gel membrane, the solid electrolyte comprises 20 wt % to 90 wt % of the composite gel membrane, and the initiator comprises 0.1 wt % to 1.0 wt % of the composite gel membrane.

15. The method of claim 11, wherein:
the polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), their corresponding oligomers and co-polymers, and combinations thereof, and
the solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, borate-based electrolytes, and combinations thereof.

16. A method for manufacturing a free-standing electrode and separator for a battery cell, comprising:
providing an electrode;
supplying a slurry for a composite gel membrane comprising a polymer, a solid electrolyte comprising greater than 20 wt % of the composite gel membrane, and an initiator onto the electrode;
compressing the slurry and the electrode between first and second rollers; and
exposing the slurry to ultraviolet (UV) light for a predetermined period at a predetermined wavelength to polymerize the polymer.

17. The method of claim 16, wherein at least one of the first and second rollers includes a radially outer surface comprising one of rubber and plastic.

18. The method of claim 17, wherein:
the predetermined period is in a range from 30 to 600 s,
the predetermined wavelength is in a range from 10 to 400 nm, and
energy of the UV light is in a range from 0.5 J/cm³ to 3 J/cm³.

19. The method of claim 17, wherein the polymer comprises 5 wt % to 30 wt % of the composite gel membrane, the solid electrolyte comprises 20 wt % to 90 wt % of the composite gel membrane, and the initiator comprises 0.1 wt % to 1.0 wt % of the composite gel membrane.

20. The method of claim 18, wherein:
the polymer is selected from a group consisting of polyethylene oxide (PEO), polyvinylidene fluoride (PVDF), polyvinylidene fluoride-hexafluoropropylene (PVDF-HFP), polypropylene oxide (PPO), polyacrylonitrile (PAN), polymethacrylonitrile (PMAN), polymethyl methacrylate (PMMA), and their corresponding oligomers and co-polymers, and
the solid electrolyte is selected from a group consisting of oxide-based solid electrolytes, metal-doped or aliovalent-substituted oxide-based electrolytes, sulfide-based electrolytes, nitride-based electrolytes, hydride-based electrolytes, halide-based electrolytes, and borate-based electrolytes.
